(19) United States
(12) Patent Application Publication
(10) Pub. No.: US 2016/0140673 A1
(43) Pub. Date: May 19, 2016

(54) PRODUCT TRACEABILITY SYSTEM AND METHOD THEREOF

(71) Applicant: INSTITUTE FOR INFORMATION INDUSTRY, Taipei City (TW)

(72) Inventors: PO-CHENG HUANG, YUNLIN COUNTY (TW); YUNG-HSING PENG, KAOHSIUNG CITY (TW); YING-HSU CHEN, KAOHSIUNG CITY (TW)

(21) Appl. No.: 14/566,025

(22) Filed: Dec. 10, 2014

(30) Foreign Application Priority Data
Nov. 14, 2014 (TW) 103139612

(51) Int. Cl. G06Q 50/02; G06Q 30/00; G06Q 10/06

(52) U.S. Cl. CPC G06Q 50/02; G06Q 10/06311; G06Q 10/06316; G06Q 30/018

(57) ABSTRACT

Disclosed are a crop traceability system and a method thereof, applied to automatically produce a multimedia resume of a crop planted at a specific geographic location. The system comprises a task generating module, a task processing module and a resume producing module. The task list generated by the task generating module comprises tasks for producing the crop, and each item has a specific position information corresponding to a specific location. An electric device is equipped with a task executing module and a multimedia generating module and thus generates a multimedia data saving a location information of the electric device and a real image information. The resume producing module compares the specific position information corresponding to the item with the location information of the electric device, so as to generate a result determining whether to use the real image information as a part of the multimedia resume of the crop.

### FIELD

The instant disclosure relates to a crop traceability system and a method thereof, and more particularly, for a crop traceability system and a method thereof, used to automatically produce a multimedia resume of a crop planted at a specific geographic location.

### BACKGROUND

With an increasing requirement for the live quality, people become more and more concerned about the source of what they eat and use in their lives. Thus, the source of material to make daily-used products and the source of food to make daily meals are supposed to be supervised so as to assure the life quality.

Take crops for example, in recent years, the crop resume has become important information for people to understand and exam the source and the planting process of the crops. However, the planting process varies in different seasons, and there are lots of species of crops. It may take lots of time to collect a large amount of field information, which results in the complexity when it comes to producing crop resumes. Additionally, if all the crop resumes are produced manually, it would be difficult to deal with the huge amount of information.

Generally speaking, the current crop resume merely tells the farm location by description in words. However, in this way, consumers can not immediately know the whole planting process of the crops. In other words, this kind of crop resume cannot provide enough authenticity to consumers because consumers would know nothing about the complete planting process of the crops, which is hard to obtain the trust of consumers and hard to bring helps as expected.

Therefore, considering people's concerning about the source of what they eat and use, and considering the increasing requirement for the producing or planting resume of daily products or crops, how to produce a resume that can both show the place of origin and the whole planting process of the crop becomes worth discussing.

### SUMMARY

The disclosed embodiments include a crop traceability system, used to automatically produce a multimedia resume of a crop planted at a specific geographic location. The crop traceability system comprises a task generating module, a task processing module and a resume producing module. The task generating module generates a task list corresponding to producing the crop, wherein the task list comprises at least one task related to producing the crop and each task has a specific position information corresponding to the specific geographic location. The task processing module transmits the task list to an electric device, wherein the electric device has a task executing module to receive the task list provided to a worker for choosing one task from the task list and a multimedia generating module to generate and transmit the multimedia data corresponding to the chosen task to the task processing module for storage. The multimedia data records a location information and a real image information of the electric device. The resume producing module produces the multimedia resume corresponding to the crop and compares the specific position information corresponding to the chosen task and the location information of the electric device to generate a result when producing the multimedia resume, wherein whether to use the real image information as a part of the multimedia resume of the crop is determined based on the result.

The instant disclosure also provides a crop traceability method, used in a specific industry for planting a crop at a specific geographic location and used to automatically produce a multimedia resume of a crop via a crop traceability system. The crop traceability system comprises a task generating module, a task processing module and a resume producing module. The crop traceability method comprises: generating a task list corresponding to producing the crop via the task generating module, wherein the task list comprises at least one task related to producing the crop and each task has a specific position information corresponding to the specific geographic location; transmitting the task list to an electric device via the task processing module, wherein the electric device has a task executing module to receive the task list provided to a worker for choosing one task from the task list and a multimedia generating module to generate and transmit a multimedia data corresponding to the chosen task to the task processing module for storage, and the multimedia data records a location information and a real image information of the electric device; and producing the multimedia resume corresponding to the crop and comparing the specific position information corresponding to the chosen task and the location information of the electric device to generate a result via the resume producing module when producing the multimedia resume, wherein whether to use the real image information as a part of the multimedia resume of the crop is determined based on the result.

To sum up, via the crop traceability system and the method thereof provided by the instant disclosure, tasks are generated from an administrator and the multimedia data is generated from a worker. After that, the information corresponding to the task and the information in the multimedia data are compared, and whether to use the real image information corresponding to the information of the task as a part of the crop multimedia resume is determined based on the result. The crop multimedia resume helps the consumer to make a query and to understand an actual plating process of the crop. Thereby, the consumer can buy and have the crop without concerning about the crop planting process.

For further understanding of the instant disclosure, reference is made to the following detailed description illustrating the embodiments and examples of the instant disclosure. The description is only for illustrating the instant disclosure, not for limiting the scope of the claim.

### BRIEF DESCRIPTION OF THE DRAWINGS

Embodiments are illustrated by way of example and not by way of limitation in the figures of the accompanying drawings, in which like references indicate similar elements and in which:

FIG. 1 shows a block diagram of a crop traceability system according to an embodiment of the instant disclosure;

FIG. 2 shows a block diagram of a task list and multimedia data according to an embodiment of the instant disclosure;

FIG. 3 shows a block diagram of a crop traceability system according to another embodiment of the instant disclosure;

FIG. 4 shows a block diagram of a task list and multimedia data according to another embodiment of the instant disclosure;

FIG. 5 shows a schematic diagram of a multimedia resume according to an embodiment of the instant disclosure;

FIG. 6 shows a flow chart of a crop traceability method according to an embodiment of the instant disclosure; and

FIG. 7 shows a flow chart of a crop traceability method according to another embodiment of the instant disclosure.

### DETAILED DESCRIPTION OF EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings. The following description is going to illustrate a crop traceability system and a method thereof provided by the instant disclosure with figures; however, it is not restricted by the embodiments below.

It will be understood that, although the terms first, second, third, and the like, may be used herein to describe various elements, components, regions, layers and/or sections, these elements, components, regions, layers and/or sections should not be limited by these terms. These terms are only to distinguish one element, component, region, layer or section from another region, layer or section discussed below could be termed a second element, component, region, layer or section without departing from the teachings of the instant disclosure. As used herein, the term “and/or” includes any and all combinations of one or more of the associated listed items.

[One Embodiment of the Crop Traceability System]

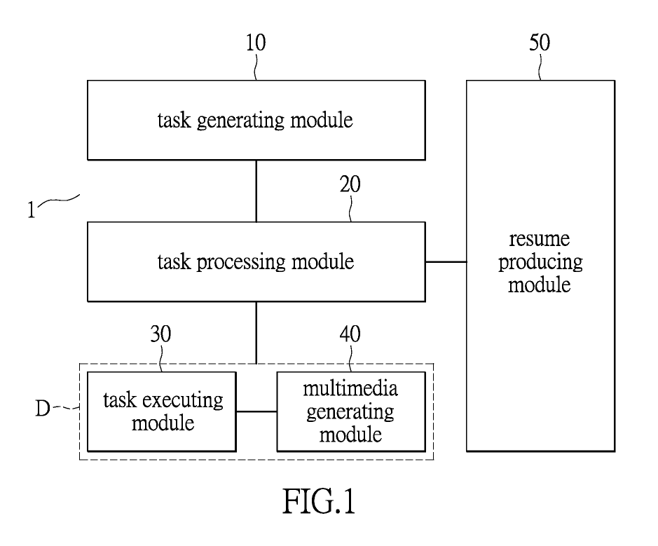

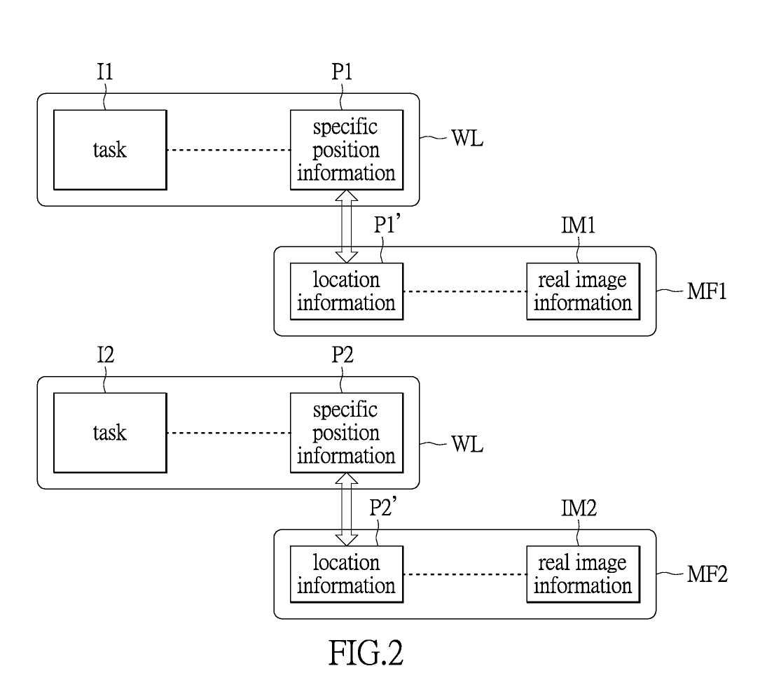

In conjunction with FIG. 1 and FIG. 2, FIG. 1 shows a block diagram of a crop traceability system according to an embodiment of the instant disclosure, and FIG. 2 shows a block diagram of a task list and multimedia data according to an embodiment of the instant disclosure.

As shown in FIG. 1, the crop traceability system 1, used to automatically produce a multimedia resume of a crop planted at a specific geographic location, comprises a task generating module 10, a task processing module 20, a task executing module 30, a multimedia generating module 40 and a resume producing module 50.

Regarding to the task generating module 10, the task generating module 10 is configured to generate a task list correspondingly for planting a crop, wherein the task list WL comprises at least one task for planting the crop and each task has a specific position information corresponding to a specific geographic location. As shown in FIG. 2, the task list WL comprises tasks I1 and I2 for planting the crop. The task I1 has a specific position information P1 corresponding to a specific geographic location, and the task I2 has a specific position information P2 corresponding to another specific geographic location.

Regarding to the task processing module 20 and the task executing module 30, the task processing module 20 is configured to transmit the task list WL to an electric device D. The electric device D has a task executing module 30 and a multimedia generating module 40. The task executing module 30 is configured to receive the task list WL for a worker to choose one of tasks therein, and each task has a specific position information. In FIG. 2, the worker can choose the task I1 or the task I2 from the task list WL after the electric device D receives the task list WL from the task processing module 20, wherein the task I1 has the specific position information P1 and the task I2 has the specific position information P2.

Regarding to the multimedia generating module 40, the multimedia generating module 40 is configured to generate multimedia data MF corresponding to the chosen task and to transmit the multimedia data MF to the task processing module 20 for storage. In FIG. 2, after the worker chooses the task I1 or the task I2 from the task list WL, the worker uses the electric device D to generate the multimedia data MF1 or uses the electric device D with certain function activated to automatically generate the multimedia data MF1 during the execution of the task I1. Or the worker uses the electric device D to generate the multimedia data MF2 or uses the electric device D with certain function activated to automatically generate the multimedia data MF2 during the execution of the task I2. The multimedia data MF1 records a real image information IM1 (such as photo or video) and the location information P1′ of the electric device D, and the multimedia data MF2 records a real image information IM2 and the location information P2′ of the electric device D, respectively.

In one embodiment regarding to planting rice, as a crop administrator manages the crop planting, the administrator generates a task list WL for planting rice via the task generating module 10, and transmits the task list WL to the electric device D held by a farmer via the task processing module 20, so as to give the planting instruction to the farmer. For example, the task I1 is seeding and the specific position information P1 is the farmland A, and the task I2 is weeding and the specific position information P2 is the farmland B. After that, the farmer learns to seed or to weed via the task list WL. Before executing the task, the farmer chooses to seed or to weed from the task list WL, and learns that the task to seed corresponds to the farmland A or that the task to weed corresponds to the farmland B. As a result, the farmer goes to the farmland A and seeds, or goes to the farmland B and weeds. During the task execution, the farmer uses the electric device D to generate the multimedia data MF1 representing a seeding action, such as a crop photo during seeding or a video showing the seeding action, and to transmit the multimedia data MF1 to the task processing module 20 for storage. Or, the farmer uses the electric device D to generate the multimedia data MF2 representing a weeding action, such as a crop photo during weeding or a video showing the weeding action, and to transmit the multimedia data MF2 to the task processing module 20 for storage. The multimedia data MF1 records the real image information IM1 showing the farmer's seeding in the farmland A and the location information P1′ of the electric device D, and the multimedia data MF2 records the real image information IM2 showing the farmer's weeding in the farmland B and the location information P2′ of the electric device D, respectively.

Regarding to the resume producing module 50, the resume producing module 50 is configured to produce a multimedia resume for the crop. When it needs to produce the multimedia resume for the crop, the resume producing module 50 compares the specific position information P1 corresponding to the task I1 in the task list WL stored in the task processing module 20 and the location information P1′ of the electric device D in the multimedia data 1 stored in the task processing module 20, so as to generate a result. Likewise, the resume producing module 50 compares the specific position information P2 corresponding to the task I2 in the task list WL stored in the task processing module 20 and the location information P2′ of the electric device D in the multimedia data MF2 stored in the task processing module 20, so as to generate a result. The resume producing module 50 determines whether to use the real image information IM1 or the real image information IM2 as a part of the multimedia resume based on the result.

In this embodiment, the multimedia data MF1 or MF2 is transmitted to the task processing module 20 via the electric device D and a communication network (such as wireless communication network) for storage after the worker uses the electric device D to generate the multimedia data MF1 or MF2 during the task execution. Please refer to FIG. 2, after all tasks in a whole season are fulfilled (assumed that all tasks in a whole season are the tasks I1 and 12 in this embodiment) and the correspondingly generated multimedia data is accumulated and stored in a database DB, the resume producing module 50 compares all multimedia data and picks up the multimedia data when it needs to produce the multimedia resume. To be detailed, the resume producing module 50 compares the specific position information P1 corresponding to the task I1 and the location information P1′ in the multimedia data MF1 after receiving the multimedia data MF1 transmitted from the task processing module 20 or receiving the multimedia data MF1 stored in the database DB. If the location information P1′ is conformed to the specific position information P1, and the resume producing module 50 determines to use the real image information IM1 in the multimedia data MF1 as a part of the multimedia resume of the crop. Or, the resume producing module 50 compares the specific position information P2 corresponding to the task I2 and the location information P2′ in the multimedia data MF2 after receiving the multimedia data MF2 transmitted from the task processing module 20 or receiving the multimedia data MF2 stored in the database DB. If the location information P2′ is conformed to the specific position information P2, and the resume producing module 50 determines to use the real image information IM2 in the multimedia data MF2 as a part of the multimedia resume of the crop. Particularly, the specific position information P1 and P2 are set by the administrator, such as the farmland A and the farmland B.

In the above embodiment regarding to planting rice, the farmer uses the electric device D to generate the multimedia data MF1 representing a seeding action or the multimedia data MF2 representing a weeding action, and to transmit the multimedia data MF1 or the multimedia data MF2 to the task processing module 20 for storage. After all tasks in a whole season are fulfilled (assumed that all tasks in a whole season are the tasks I1 and I2 in this embodiment) and the correspondingly generated multimedia data is accumulated and stored in a database DB, the task processing module 20 transmits the multimedia data MF1 showing the seeding action or the multimedia data MF2 showing the weeding action to the resume producing module 50, and the resume producing module 50 compares all multimedia data and picks up the multimedia data when it needs to produce the multimedia resume. To be detailed, the resume producing module 50 compares the farmland A corresponding to the seeding action and the location information P1′ in the multimedia data MF1 after receiving the multimedia data MF1 transmitted from the task processing module 20. If the farmland A is conformed to the location information P1′, and the resume producing module 50 determines to use the real image information IM1 in the multimedia data MF1 as a part of the multimedia resume of rice. Or, the resume producing module 50 compares the farmland B corresponding to the weeding action and the location information P2′ in the multimedia data MF2 after receiving the multimedia data MF2 transmitted from the task processing module 20. If the farmland B is conformed to the location information P2′, and the resume producing module 50 determines to use the real image information IM2 in the multimedia data MF2 as a part of the rice multimedia resume of rice.

It needs to be noted that, in another embodiment, the multimedia data MF1 or MF2 is directly transmitted to the resume producing module 50 via the electric device D and the communication network after the worker uses the electric device D to generate the multimedia data MF1 or MF2. In other words, after the electric device D generates the multimedia data MF1 or MF2, the multimedia data MF1 or MF2 would not be transmitted to the task processing module 20 for storage but directly and immediately transmitted to the resume producing module 50. After that, the resume producing module 50 automatically uses the conformed real image information IM1 or IM2 as a part of the multimedia resume for the crop. Herein, how to determine whether to use the real image information IM1 or IM2 as a part of the multimedia resume for the crop and how to produce the multimedia resume are the same as the operation of the above embodiments substantially, so the skilled in the art would be able to comprehend and further descriptions are therefore omitted.

Moreover, in the above embodiments, the electric device D may be a mobile phone, a tablet or any kind of portable electric device to receive the task list WL via the communication network, and it is not limited thereto. Also, the real image information in the multimedia data generated by the electric device D during the task execution may be photos. For example, the real image information IM1 is a photo of seeding and the real image information IM2 is a photo of weeding, but it is not limited thereto.

[Another Embodiment of the Crop Traceability system]

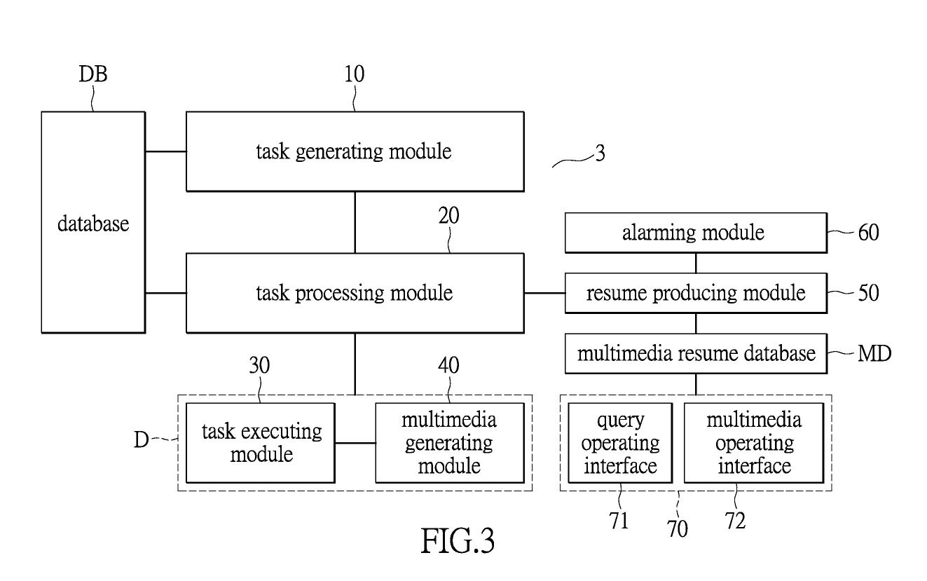

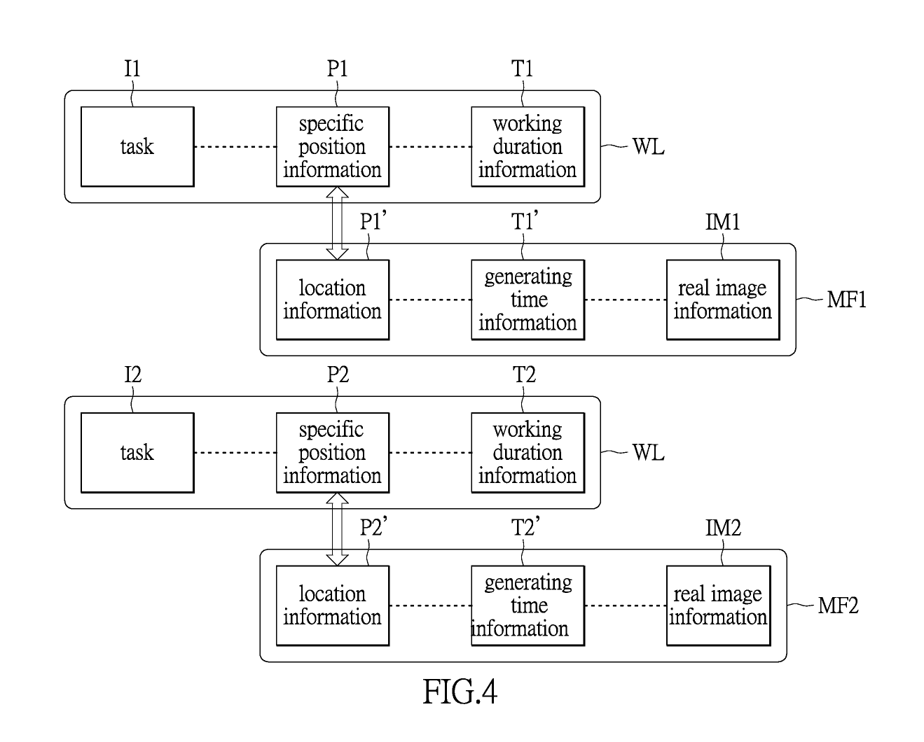

In conjunction with FIG. 3 and FIG. 4, FIG. 3 shows a block diagram of a crop traceability system according to another embodiment of the instant disclosure, and FIG. 4 shows a block diagram of a task list and multimedia data according to another embodiment of the instant disclosure.

As shown in FIG. 3, the crop traceability system 3, used to automatically produce a multimedia resume of a crop planted at a specific geographic location, comprises a task generating module 10, a task processing module 20, a task executing module 30, a multimedia generating module 40, a resume producing module 50, an alarming module 60 and a query interface module 70, wherein the query interface module 70 comprises a query operating interface 71 and a multimedia operating interface 72.

In the following embodiments, there are only parts different from embodiments in FIGS. 1 and 2 described, and the omitted parts are indicated to be identical to the embodiments in FIGS. 1 and 2. In addition, for an easy instruction, similar reference numbers or symbols refer to elements alike.

The crop traceability system 3 is similar to the crop traceability system 1 of the previous embodiment. The difference between the crop traceability system 3 and the crop traceability system 1 is that the crop traceability system 3 further comprises the alarming module 60 and the query interface module 70, wherein the query interface module 70 comprises the query operating interface 71 and the multimedia operating interface 72. Additionally, in the crop traceability system 3, the task generating module 10 and the task processing module 20 are connected to a database DB, and the resume producing module 50 and the query interface module 70 are connected to a multimedia resume database MD.

In this embodiment, a plurality of task lists preset by the administrator and the corresponding electric devices are recorded in the database DB. The task generating module 10 generates a task list WL for a crop via the database DB and correspondingly transmits the task list WL to the task processing module 20. The task list WL comprises at least one task for planting the crop and each task has the specific position information corresponding to a specific geographic location.

After that, the task processing module 20 transmits the received task list WL to the corresponding electric device D. The electric device D has a task executing module 30 and a multimedia generating module 40. The task executing module 30 is configured to receive the task list WL for the worker to choose one of the tasks, wherein each task corresponds to a specific position information.

As shown in FIG. 3, the worker chooses the task I1 or I2 from the task list WL after the electric device D receives the task list WL from the task processing module 20, wherein the task I1 corresponds to a specific position information P1 and a working duration information T1, and the task I2 corresponds to a specific position information P1 and a working duration information T1.

The worker uses the electric device D to generate the multimedia data MF1 when executing the task I1 or to generate the multimedia data MF2 when executing the task I2 after choosing the task I1 or the task I2 from the received task list WL via the electric device D. The multimedia data MF1 records a real image information IM1, a generating time information T1′ and a location information P1′ of the electric device D, and the multimedia data MF2 records a real image information IM2, a generating time information T2′ and a location information P2′ of the electric device D.

In one embodiment regarding to planting rice, the farmer learns to seed and to weed via the task list WL. Before starting to work, the farmer chooses to execute seeding or weeding and learns that the seeding must be executed for the farmland A within a work duration A or that the weeding must be executed for the farmland B within a work duration B.

In this embodiment, the multimedia data MF1 or MF2 is transmitted to the task processing module 20 via the electric device D for storage after the worker uses the electric device D to generate the multimedia data MF1 or MF2 when working. Please refer to FIG. 4, after all tasks in a whole season are fulfilled (assumed that all tasks in a whole season are the tasks I1 and I2 in this embodiment) and the correspondingly generated multimedia data is accumulated and stored in a database DB, the resume producing module 50 compares all multimedia data and picks up the multimedia data. Further, the resume producing module 50 receives the multimedia data MF1 or MF2 transmitted by the task processing module 20 or obtains the multimedia data MF1 or MF2 from the database DB. The resume producing module 50 compares the location information P1′ and the generating time information T1′ in the multimedia data MF1 with the specific position information P1 and the working duration information T1 corresponding to the task I1, or compares the location information P2′ and the generating time information T2′ in the multimedia data MF2 with the specific position information P2 and the working duration information T2 corresponding to the task I2.

If the location information P1′ is conformed to the specific position information P1 and the generating time information T1′ is conformed to the working duration information T1, the resume producing module 50 would determine to use the real image information IM1 in the multimedia data MF1 as a part of the multimedia resume of the crop. Or, if the location information P2′ is conformed to the specific position information P2 and the generating time information T2′ is conformed to the working duration information T2 the resume producing module 50 would determine to use the real image information IM2 in the multimedia data MF2 as a part of the multimedia resume of the crop. The specific position information P1 and the specific position information P2 are set by the administrator, and the working duration information T1 and the working duration information T2 are also set by the administrator.

However, if the location information P1′ is not conformed to the specific position information P1 or the generating time information T1′ is not conformed to the working duration information T1, it would generate an abnormal result so that the resume producing module 50 chooses not to use the real image information IM1 of the multimedia data MF1 as a part of the multimedia resume of the crop. Additionally, the resume producing module 50 further informs the alarming module 60 at the same time, and the alarming module 60 alarms the administrator. Likewise, if the location information P2′ is not conformed to the specific position information P2 or the generating time information T2′ is not conformed to the working duration information T2, it would generate an abnormal result so that the resume producing module 50 chooses not to use the real image information IM2 of the multimedia data MF2 as a part of the multimedia resume of the crop. Additionally, the resume producing module 50 further informs the alarming module 60 at the same time, and the alarming module 60 alarms the administrator.

In the above embodiment regarding to planting rice, if the location information P1′ of the electric device D is not within the farmland A or the generating time information T1′ is not within the work duration A, it would generate an abnormal result so that the resume producing module 50 chooses not to use the real image information IM1 of the multimedia data MF1 as a part of the multimedia resume of rice. Additionally, the resume producing module 50 further informs the alarming module 60 and the alarming module 60 alarms the administrator. Likewise, if the location information P2′ of the electric device D is not within the farmland A or the generating time information T2′ is not within the work duration A, it would generate an abnormal result so that the resume producing module 50 chooses not to use the real image information IM2 of the multimedia data MF2 as a part of the multimedia resume of rice. Additionally, the resume producing module 50 further informs the alarming module 60 at the same time, and the alarming module 60 alarms the administrator. Via the alarming module 60, if the farmer does not execute the task according to the task list or there is certain emergence, the administrator would be informed.

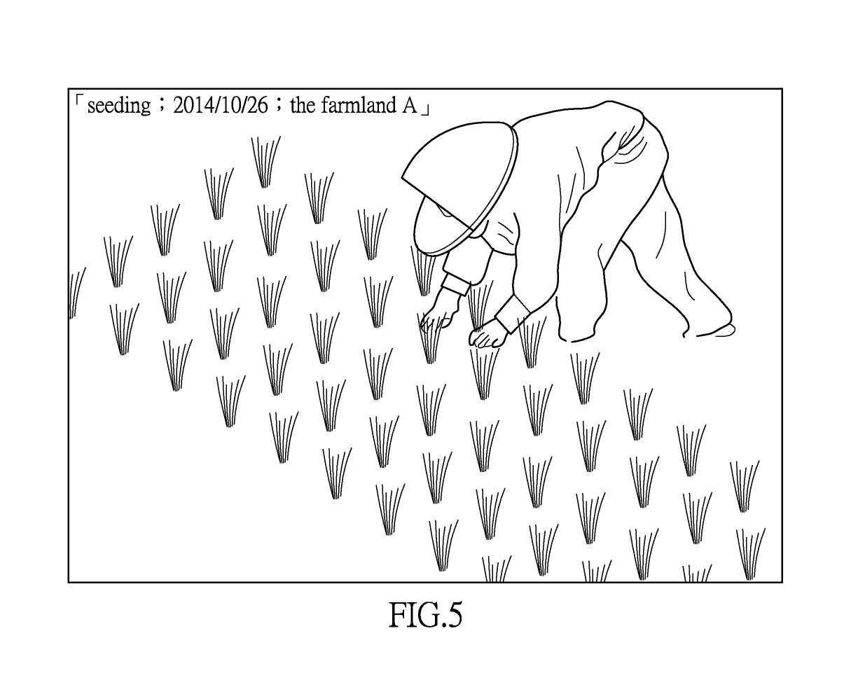

In conjunction with FIG. 3, FIG. 4 and FIG. 5, FIG. 5 shows a schematic diagram of a multimedia resume according to an embodiment of the instant disclosure.

In this embodiment, when it needs to produce the multimedia resume, the resume producing module 50 uses the real image information IM in each conformed multimedia data together with the corresponding task, the corresponding working duration information and the specific position information in the task list WL to be as a part of the multimedia resume of the crop. After that, the multimedia resume of the crop is transmitted to the multimedia resume database MD for storage. Finally, the consumer uses the query operating interface 71 of the query interface module 70 to query the multimedia resume stored in the multimedia resume database MD, and uses the multimedia operating interface 72 of the query interface module 70 to play the multimedia resume.

In the above embodiment regarding to planting rice, when it needs to produce the multimedia resume, the resume producing module 50 uses the conformed multimedia data MF1 together with the task I1, the corresponding working duration information T1 and the specific position information P1 to be as a part of the multimedia resume of rice. As shown in FIG. 5, FIG. 5 shows a part of the multimedia resume of rice which is shown as a photo with a description about the seeding action, the work duration A and the farmland A, and this part of the multimedia resume is stored in the multimedia resume database MD. The consumer queries the multimedia resume of rice in the multimedia resume database MD via the query operating interface 71 of the query interface module 70. The multimedia operating interface 72 of the query interface module 70 plays all parts of the multimedia resume of rice sequentially according to the time when the parts of the multimedia resume of rice are stored in the multimedia resume database MD, and the played parts of the multimedia resume of rice form a multimedia resume of rice.

To be detailed, the content of the multimedia resume of each crop stored in the multimedia resume database MD would increase with the tasks increasing. Thus, the content of the multimedia resume may comprise a plurality of tasks including from seeding to harvesting, and also may comprise some of tasks so far, such as seeding but no harvesting yet. Moreover, if it turns into the next season, the content of the multimedia resume may comprise identical tasks with different working duration information.

Therefore, in this embodiment, with the increasing content of the multimedia resume, when the resume producing module 50 stores the produced parts of the multimedia resume in the multimedia resume database MD, it further revises the content of the multimedia resume. Regarding to the revision of the multimedia resume, a next task corresponding different working duration information can just overlay the last task (the next task and the last task are the same but have different working duration information), or the next and the last tasks are saved and used to produce different multimedia resumes of different seasons depending on different working duration information. Herein, how to revise the multimedia resume is not limited.

In one embodiment, the multimedia data MF1 or MF2 would be directly transmitted to the resume producing module 50 after the worker uses the electric device D to generate the multimedia data MF1 or MF2 via the electric device D. It should be noted that, in this embodiment, the multimedia data MF1 or MF2 would not be transmitted to the task processing module 20 for storage but directly and immediately transmitted to the resume producing module 50 after the electric device D generates the multimedia data MF1 or MF2. The resume producing module 50 automatically uses the real image information IM1 or IM2 in the conformed multimedia data MF1 or MF2 as a part of the multimedia resume. Herein, how to determine whether to use the real image information IM1 or IM2 as a part of the multimedia resume for the crop, how to produce the multimedia resume and how to alarm the administrator for an abnormal result are the same as the operation of the above embodiments substantially, so the skilled in the art would be able to comprehend and further descriptions are therefore omitted.

[One Embodiment of the Crop Traceability Method]

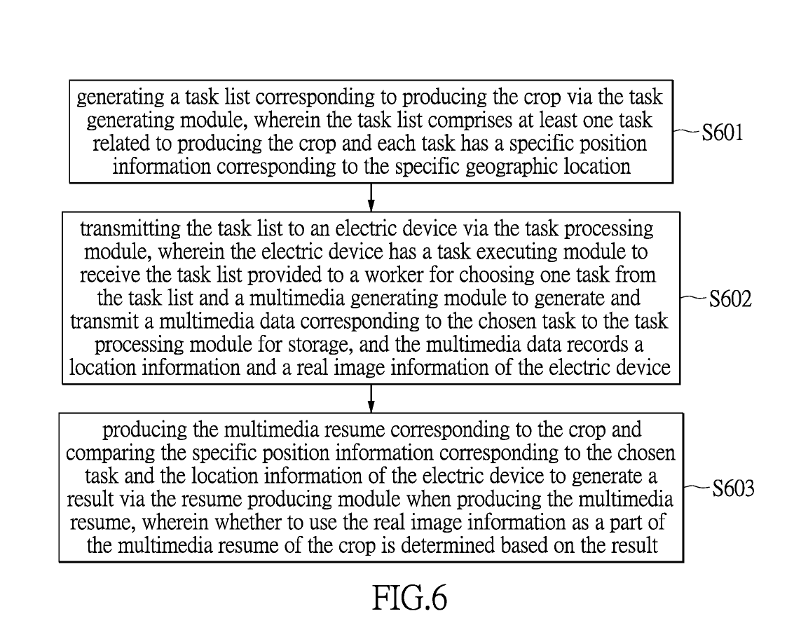

Please refer to FIG. 6, FIG. 6 shows a flow chart of a crop traceability method according to an embodiment of the instant disclosure. The method of this embodiment may be conducted in the crop traceability system 1 shown in FIG. 1 with the task list WL and the multimedia data shown in FIG. 2, and thus please refer to FIGS. 1-2 for further understanding.

A crop traceability method 600 used in a specific industry for planting a crop at a specific geographic location and used to automatically produce a multimedia resume of a crop comprises steps as follows: generating a task list corresponding to producing the crop via the task generating module 10, wherein the task list comprises at least one task related to producing the crop and each task has a specific position information corresponding to the specific geographic location (Step S601); transmitting the task list to an electric device via the task processing module 20, wherein the electric device D has a task executing module 30 to receive the task list WL provided to a worker for choosing one task from the task list WL and a multimedia generating module 40 to generate and transmit a multimedia data corresponding to the chosen task to the task processing module 20 for storage, and the multimedia data records a location information and a real image information of the electric device D, such as photos or videos (Step S602); and producing the multimedia resume corresponding to the crop and comparing the specific position information corresponding to the chosen task and the location information of the electric device to generate a result via the resume producing module 50 when producing the multimedia resume, wherein whether to use the real image information as a part of the multimedia resume of the crop is determined based on the result (Step S603).

Relevant details of the steps of the crop traceability method 600 used in a specific industry for planting a crop at a specific geographic location and used to automatically produce a multimedia resume of a crop are described in the embodiments of FIGS. 1, 2 and 5, and thus it is not repeated thereto.

It should be noted that, in one embodiment, in the step S602, after the multimedia generating module 40 generates the multimedia data corresponding to the chosen task, the multimedia data is not transmitted to the task processing module 20 for storage but directly and immediately transmitted to the resume producing module 50. Additionally, in the above step S603, the resume producing module 50 automatically uses the real image information in the conformed multimedia data as a part of the multimedia resume of the crop.

[Another Embodiment of the Crop Traceability Method]

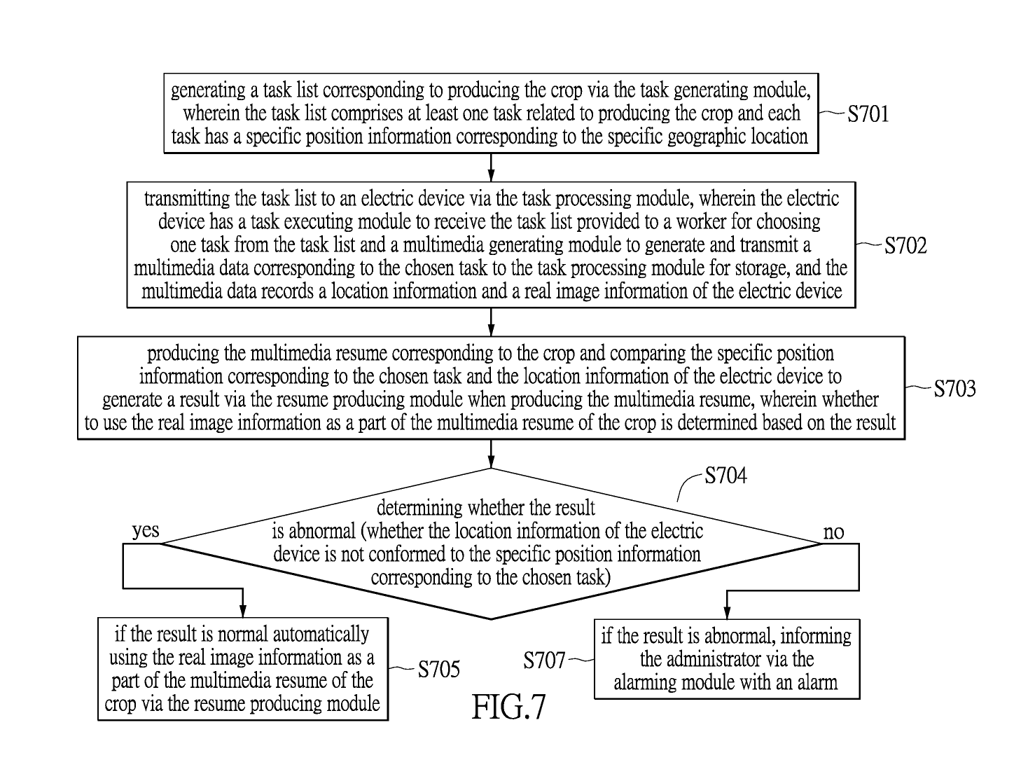

Please refer to FIG. 7, FIG. 7 shows a flow chart of a crop traceability method according to another embodiment of the instant disclosure. The method of this embodiment may be conducted in the crop traceability system 3 shown in FIG. 3 with the task list WL and the multimedia data shown in FIG. 4, and thus please refer to FIGS. 3-4 for further understanding.

A crop traceability method 700 used in a specific industry for planting a crop at a specific geographic location and used to automatically produce a multimedia resume of a crop comprises steps as follows: generating a task list corresponding to producing the crop via the task generating module 10, wherein the task list comprises at least one task related to producing the crop and each task has a specific position information corresponding to the specific geographic location (Step S701); transmitting the task list to an electric device via the task processing module 20, wherein the electric device D has a task executing module 30 to receive the task list WL provided to a worker for choosing one task from the task list WL and a multimedia generating module 40 to generate and transmit a multimedia data corresponding to the chosen task to the task processing module 20 for storage, and the multimedia data records a location information and a real image information of the electric device D, such as photos or videos (Step S702); producing the multimedia resume corresponding to the crop and comparing the specific position information corresponding to the chosen task and the location information of the electric device to generate a result via the resume producing module 50 when producing the multimedia resume, wherein whether to use the real image information as a part of the multimedia resume of the crop is determined based on the result (Step S703); determining whether the result is abnormal (whether the location information of the electric device is not conformed to the specific position information corresponding to the chosen task) (Step S704); if the result is normal automatically using the real image information as a part of the multimedia resume of the crop via the resume producing module 50 (Step S705); and if the result is abnormal, informing the administrator via the alarming module 60 with an alarm (Step S707).

Relevant details of the steps of the crop traceability method 700 used in a specific industry for planting a crop at a specific geographic location and used to automatically produce a multimedia resume of a crop are described in the embodiments of FIGS. 3, 4 and 5, and thus it is not repeated thereto.

It should be noted that, in one embodiment, in the step S702, after the multimedia generating module 40 generates the multimedia data corresponding to the chosen task, the multimedia data is not transmitted to the task processing module 20 for storage but directly and immediately transmitted to the resume producing module 50 for making a comparison.

To sum up, via the crop traceability system and the method thereof provided by the instant disclosure, tasks are generated from an administrator and the multimedia data is generated from a worker. After that, the information corresponding to the task and the information in the multimedia data are compared, and whether to use the real image information corresponding to the information of the task as a part of the crop multimedia resume is determined based on the result. The crop multimedia resume helps the consumer to make a query and to understand an actual plating process of the crop. Thereby, the consumer can buy and have the crop without concerning about the crop planting process.

The descriptions illustrated supra set forth simply the embodiments of the instant disclosure; however, the characteristics of the instant disclosure are by no means restricted thereto. All changes, alterations, or modifications conveniently considered by those skilled in the art are deemed to be encompassed within the scope of the instant disclosure delineated by the following claims.

What is claimed is:

1. A crop traceability system, used to automatically produce a multimedia resume of a crop planted at a specific geographic location, comprising:
a task generating module, generating a task list corresponding to producing the crop, wherein the task list comprises at least one task related to producing the crop and each task has a specific position information corresponding to the specific geographic location;
a task processing module, transmitting the task list to an electric device, wherein the electric device has a task executing module to receive the task list provided to a worker for choosing one task from the task list and a multimedia generating module to generate and transmit a multimedia data corresponding to the chosen task to the task processing module for storage, and the multimedia data records a location information and a real image information of the electric device; and
a resume producing module, producing the multimedia resume corresponding to the crop and comparing the specific position information corresponding to the chosen task and the location information of the electric device to generate a result when producing the multimedia resume, wherein whether to use the real image information as a part of the multimedia resume of the crop is determined based on the result.

2. The crop traceability system according to claim 1, wherein the multimedia data is a photo.

3. The crop traceability system according to claim 1, wherein the task generating module and the task processing module are connected to a database to record the task list and the electric device and the multimedia data corresponding to the task list.

4. The crop traceability system according to claim 1, wherein the task list further records a working duration information corresponding to each task, the multimedia data further records a generating time information, and the resume producing module further compares the working duration information corresponding to the chosen task and the generating time information of the multimedia data so as to generate a result.

5. The crop traceability system according to claim 1, further comprising a multimedia resume database storing the multimedia resume generated by the resume producing module.

6. The crop traceability system according to claim 5, further comprising a query interface module, the query interface module comprising a query operating interface and a multimedia operating interface, wherein the query operating interface is provided to a consumer for searching the multimedia resume in the multimedia resume database and the multimedia operating interface is configured to play the multimedia resume.

7. The crop traceability system according to claim 1, further comprising an alarming module informing an administrator with an alarming when the result is abnormal.

8. The crop traceability system according to claim 1, wherein the resume producing module automatically uses the real image information as a part of the multimedia resume when the result is conformed.

9. A crop traceability method, used in a specific industry for planting a crop at a specific geographic location and used to automatically produce a multimedia resume of a crop via a crop traceability system, the crop traceability system comprising a task generating module, a task processing module and a resume producing module, the crop traceability method comprising:
generating a task list corresponding to producing the crop via the task generating module, wherein the task list comprises at least one task related to producing the crop and each task has a specific position information corresponding to the specific geographic location;
transmitting the task list to an electric device via the task processing module, wherein the electric device has a task executing module to receive the task list provided to a worker for choosing one task from the task list and a multimedia generating module to generate and transmit a multimedia data corresponding to the chosen task to the task processing module for storage, and the multimedia data records a location information and a real image information of the electric device; and
producing the multimedia resume corresponding to the crop and comparing the specific position information corresponding to the chosen task and the location information of the electric device to generate a result via the resume producing module when producing the multimedia resume, wherein whether to use the real image information as a part of the multimedia resume of the crop is determined based on the result.

10. The crop traceability method according to claim 9, wherein the multimedia data is a photo.

11. The crop traceability method according to claim 9, wherein the task generating module and the task processing module are connected to a database to record the task list and the electric device and the multimedia data corresponding to the task list.

12. The crop traceability method according to claim 9, wherein the task list further records a working duration information corresponding to each task, the multimedia data further records a generating time information, and the resume producing module further compares the working duration information corresponding to the chosen task and the generating time information of the multimedia data so as to generate a result.

13. The crop traceability method according to claim 9, wherein the crop traceability system further comprises a multimedia resume database storing the multimedia resume generated by the resume producing module.

14. The crop traceability method according to claim 13, wherein the crop traceability system further comprises a query interface module, the query interface module comprises a query operating interface and a multimedia operating interface, and a consumer searches the multimedia resume in the multimedia resume database via the query operating interface and plays the multimedia resume via the multimedia operating interface.

15. The crop traceability method according to claim 9, wherein the crop traceability system further comprises an alarming module informing an administrator with an alarming when the result is abnormal.

16. The crop traceability method according to claim 9, wherein the resume producing module automatically uses the real image information as a part of the multimedia resume when the result is conformed.
